(19) United States
(12) Patent Application Publication
(10) Pub. No.: US 2013/0204828 A1
(43) Pub. Date: Aug. 8, 2013

(54) System and Method for Enhanced, Flexible Mail Address Validation and Hygiene

(71) Applicants: Cameron Bellamy, Danbury, CT (US); Raymond Chin, Owings, MD (US); Everette Mills, Lafayette, IN (US); Angelo Anagnostopoulos, Red Rock, AZ (US); Junguo Gao, Robbinsville, NJ (US); Therese Powers, Bristol, VA (US)

(72) Inventors: Cameron Bellamy, Danbury, CT (US); Raymond Chin, Owings, MD (US); Everette Mills, Lafayette, IN (US); Angelo Anagnostopoulos, Red Rock, AZ (US); Junguo Gao, Robbinsville, NJ (US); Therese Powers, Bristol, VA (US)

(73) Assignee: Grayhair Software, Inc., Mount Laurel, NJ (US)

(21) Appl. No.: 13/368,425

(22) Filed: Feb. 8, 2012

(51) Int. Cl. G06N 5/02

(52) U.S. Cl. 706/47

(57) ABSTRACT

A method for reformatting and updating mailing addresses in a mailing address database to maximize postal rate discounts while enforcing a set of business rules dictating the circumstances under which individual mailing addresses may be changed and for setting a disposition status for each mailing address based on the application of the business rules and the outcome of process to reformat and update the mailing addresses.

### FIELD OF THE INVENTION

The invention pertains to the field of mass mailings and the systems and methods used to properly format, check and verify the addressing of individual mail pieces to maximize the available discounts of postage rates.

### BACKGROUND OF THE INVENTION

The U.S. Postal Service® provides discounted postal rates for large mailings when the mailer complies with certain guidelines and standards for the addressing, formatting and pre-sorting of multiple mail pieces. Mailers can realize a significant savings in postal rates by compliance with the post office's standards. This discount would be sought by companies engaging in, for example, mass marketing direct mail campaigns or the mailing of monthly statements to customers.

The Coding Accuracy Support System (CASS™) is a standard that enables the United States Postal Service® to evaluate the accuracy of software that corrects and matches street addresses. Software in compliance with CASS is able to validate addresses, place addresses in a standard form, check spelling of street names, change 5-digit ZIP Codes™ into Zip+4™ codes, adding the POSTNET™ barcode, etc. The standard provides a test that must be passed by the software before it becomes CASSCertified™. Many vendors supply CASS-certified software to perform this function.

The National Change of Address (NCOA^{Link}) registry is a database containing new addresses of individuals, families or businesses that have moved. An entry is made in the NCOA^{Link} database when a “Change of Address” card is submitted to the post office. Software is available that will update mailing list address databases to reflect the new addresses. NCOA^{Link} is also able to verify that an address provided on a change of address card is a deliverable address.

Mass mailings may be created and prepared in house for mailing but are often contracted to large “mail houses” who will prepare the mailing and address the mail pieces based on a mailing list database provided by the mailer. A mail house will typically scrub the client's mailing list with CASS-compliant software and apply changes from the NCOA^{Link} database before posting the mail pieces.

One problem with such an arrangement is that there is no flexibility for the mailer as to the disposition of individual mail pieces based on the outcome of the pre-mailing processing. As an example, a mortgage company is required by contract or regulation to send a mortgage statement to the address it has on record for its customer, but the NCOA^{Link} database indicates that the customer has moved. The mortgage company needs to be able to ignore the changed address and send the mail piece to the address it has on file. As another example, an insurance company is licensed in one state but not another and is sending a marketing piece to potential clients in the state in which it is licensed. The database indicates that a recipient has moved to the state where the insurance company is not licensed, so it is desirable that a mail piece not be sent to that individual.

It would therefore be desirable to allow the application of business-specific and mailing-specific rules to determine the final disposition of individual mail pieces based on the status of the mail piece after pre-mailing processing.

### SUMMARY OF THE INVENTION

The present invention allows for the analysis of the disposition of specific mail pieces based on the results of pre-mailing processing, including the application of CASS-certified software and comparison with the NCOA^{Link} database, as well as other, proprietary processes, which will be discussed below.

The status of individual mail pieces will be determined based on the results of the pre-mailing processing and the application of a set of business rules to determine if (a) an individual mail piece should be mailed or not; (b) what address the individual mail piece should be sent to; (c) what postal rate should be applied to the individual mail piece; (d) whether the mail piece may be pre-sorted, etc. All of these options are determined based on the results of the various pre-mailing processes and analysis of the outcomes of these processes in light of the applicable business rules for the particular mailing.

In the preferred embodiment of the invention, any individual mail piece may be assigned a disposition status. As an example, the individual mail piece may be assigned a status selected from this list:
Mail at the single piece, undiscounted rate
Mail at the non-auto presort discount rate
Mail at the full discount rate
Do not mail
Mail in a new package (provide special handling of the mail piece)
Foreign address—mail to the foreign address
Foreign address—do not mail

As will be realized, other final statuses for individual mail pieces could be applied.

The system may be implemented as a service wherein the client (i.e., the mailer or the contracted mail house) is provided with client software, which is run locally and which sends the necessary information to an in-house server, which does the pre-mailing processing and application of the business rules. The communication of the necessary information may be performed, for example, over the Internet via a secure connection. The results are then returned to the client via this same connection. The applicable business rules are set up with the mailer prior to the processing of the mail pieces.

This system and method provides level of analysis and flexibility as to the final disposition of individual mail pieces in a mass mailing not previously available in the industry.

### BRIEF DESCRIPTION OF THE DRAWINGS

FIG. 1 shows a diagram of a system on which the preferred embodiment of the invention would execute.

FIG. 2 shows a flow chart of the process of the present invention.

FIG. 3 shows a data-flow diagram of the present invention and the application of the specific rules used to assign final status to individual mail pieces.

### DETAILED DESCRIPTION OF THE INVENTION

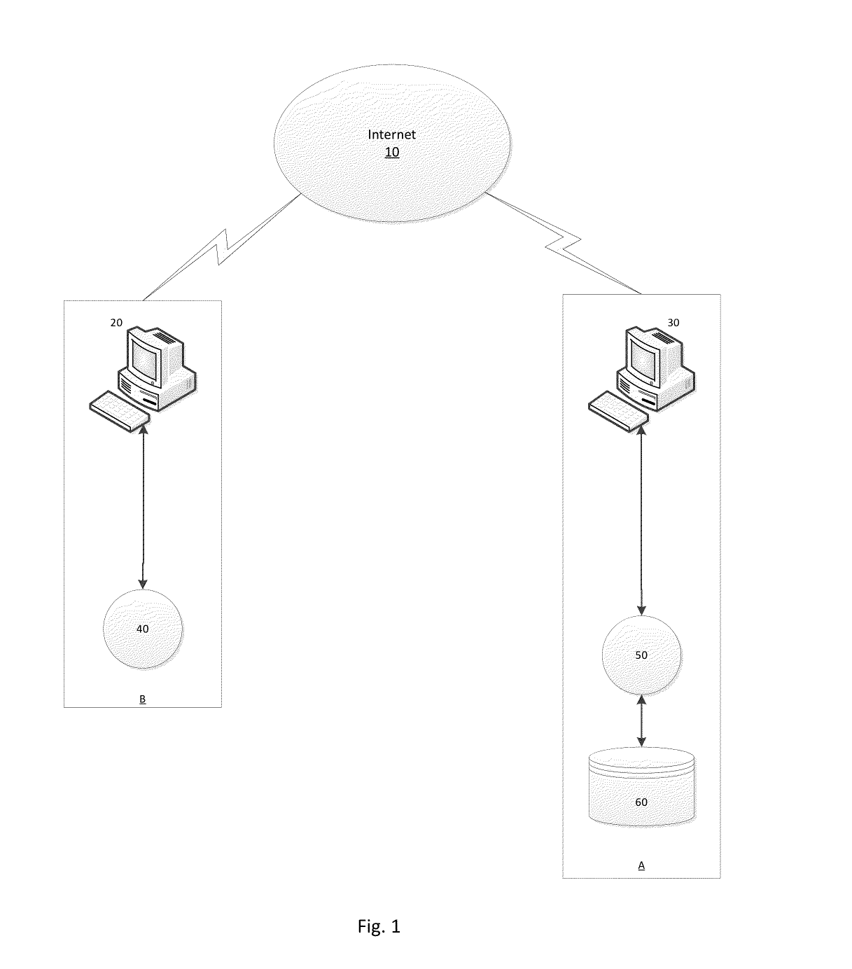

As shown in FIG. 1, in the preferred embodiment of the process of the current invention, a mailing list database is received from a mail house or lettershop “A” and processed at a remote location “B”. The processed mailing list is then returned to lettershop A with the final disposition status of each individual mail piece indicated. Lettershop A then creates and addresses the mail pieces in accordance with the final disposition statuses.

Typically, a mailing list database 60 would be received from a client and would be resident on the computer system of lettershop A. Mailing list database 60 would be received at remote location B over a secure Internet connection 10, however, any well-known method of transfer may be used including through the transfer of physical media. Preferably, a software client 50 is provided access to and running on the computer systems of lettershop A.

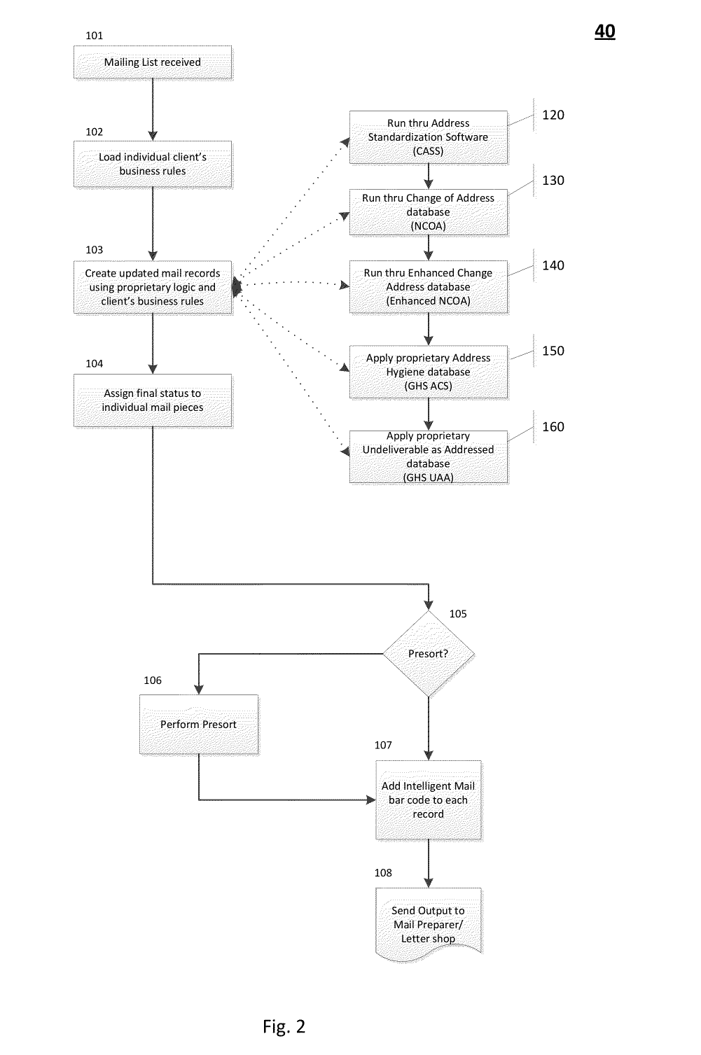

As all of the information in the mailing list database 60 may not be necessary to carry out the objects of this invention, software client 50 gathers only the data necessary to do the processing in accordance with the process of the present invention and sends it to server 20 at remote location B where process 40, implementing the objects of the invention as shown in FIG. 2, is executed. For purposes of this explanation, the term “mailing list database” refers both to the whole database or only that information from the mailing list database necessary for process 40.

After processing, the mailing list database 60 is sent back to lettershop A, where it is received by the client software 50, which may merge the processed data with other data in mailing list database 60.

Server 20 is a computer system of a type that is well known and commercially available, preferably having an Internet connection 10 and has process 40 implemented as software resident thereon. In an alternate embodiment, lettershop A may run software implementing the process 40 of the invention in-house, thereby eliminating the need to transfer the required data to remote location B.

Process 40 is explained with reference to FIG. 2. In box 101, the mailing list database 60 (or the portion of mailing list 60 which is necessary to the process 40 of the invention) is received from the lettershop A. As previously stated, mailing list database 60 may be received via secure Internet connection or by any other well-known means.

At box 102, the business rules specific to the client for whom the process is being completed are loaded into the system. Note that process 40 may be provided with a user interface for setting up the specific business rules for mailing list database 60.

The basic process of the present invention includes several sub-processes, shown as 120-160 in FIG. 2, each performing specific tasks involving the manipulation of records in mailing list database 60. The business rules set-up procedure in step 102 of process 40 specifies rules for specific circumstances, which may occur as the result of the processing performed by each sub-process 120-160, which are explained below.

At box 120, the records in the mailing list database may be placed in to a standardized format in accordance with the U.S. Post Office's CASS Standard and may also be verified as being valid addresses to which mail may be delivered. The business rules set up in step 102 may specify various options for this process, both in the changing of the addresses and in the assigning of final disposition status for each individual mail piece.

For instance, in some cases the address may be found to not be in standard form, but may not be corrected because of regulations. For example, a mortgage lender may be required to send a statement to the address for the customer that it has on record. In such a case, many non-standard addresses may be left unchanged, which would tend to decrease the discount available for the mailing. A client sending advertising pieces, on the other hand, will want to standardize every address to maximize the available discount.

Business rules may also be set up to determine the final disposition status of individual mail pieces depending on what happens during the CASS processing. As the CASS process 120 also verifies information, the final disposition status may be dependent on this verification. For example, a credit card company may not wish to post statements to addresses that cannot be verified, to minimize risk of fraud, or a mailing to an unverified address may not qualify for the full postage rate discount.

In box 130, addresses in mailing list database 60 may be changed based upon submission of a card by the recipient to the National Change of Address Database. Again, as in the previous step, certain business rules are set for this process.

In box 140, there is an option for the user to run the input addresses through an enhanced change of address database, which may be a proprietary database. This database may contain address changes, which are not, for various reasons, in the National Change of Address Database. The enhanced address change database contains known address changes, which become known by means other than by the submission of a Change of Address card by the recipient, or which are available from other sources. Business rules may exist for a particular client to give precedence to address changes in one database but not the other, for example, when no address change is indicated in the NCOA database, but a new address is indicated in the enhanced change of address database.

The processing in boxes 150 and 160 are similar. In step 150, the addresses in the mailing list are checked against an address change service (ACS™). This service is available from the U.S. Post Office and indicates what has happened to mail addressed to the particular recipient. For example, it indicates that mail addressed to a recipient at a particular address was successfully forwarded to a new address. The client may have the option of using this new address or not. Note that the business rule set up may indicate different actions for first class mail versus standard class mail. For example, if the mail is First-Class Mail® it may be forwarded or returned to the sender in the event that it could not be forwarded, while Standard Mail® would be destroyed.

In step 160, an enhanced ACS is provided which utilizes aggregated ACS information from many clients. Individual clients may decide to allow access to their ACS information in return for access to the ACS information from other clients. This is helpful in the case where an individual is on the mailing lists of multiple clients and the individual informs one client of an address change but not others. If recipient is not in the National Change of Address Database and the software determines that the mail is undeliverable, the proprietary database may be consulted to determine if another client has the new address for the recipient. Naturally because some of the databases are proprietary, the client must give his permission before his database is aggregated with the databases of other clients.

Once processing is completed based on CASS, NCOA and ACS data, various global and local business rules may further be applied in box 103. Such rules are applied to create a balance between obtaining the best possible postage rates while meeting postal regulations and business restrictions placed on mandatory mailing addresses. Global rules are provided to enforce a best practice on meeting USPS® Move Update regulations and proper addressing methods. As an example, where a house number is incorrect and cannot be remedied, by USPS regulation a full postage-rate discount may not be obtained; however, some non-automation presort-rate discount may be available or the piece can still be mailed at the full single-piece rate. The global rules prevent the client from making incorrect rules that could violate USPS regulations.

Local rules are set up to ensure that a client's business rules are met. These rules concentrate on business restrictions and mailing compliance and take into account whether an address can be changed or not.

In box 104, a final status indicating the disposition of each individual mail piece is applied, depending upon the results of the processes in 103 and 120-160. In the preferred embodiment of the invention, there are several possible statuses, including:

1. Single Piece—indicates that the individual mail piece is to be mailed at the full postage rate without any automation or Move Update discounts applied.

2. Non-Auto Presort—indicates that the mail piece contains at least a 5-digit ZIP Code; the lowest level of postal discounts apply.

3. Discount—indicates that the mail piece has a valid 11-digit ZIP Code and is eligible to be run through the presort process. The postal regulations required to achieve postal automation discount levels have been met.

4. Do Not Mail—indicates that the mail piece should not be mailed. This may be due to a specific business rule imposed by the client or because the address cannot be verified as a valid mailing address.

5. Mail In New Package—indicates that the mail piece is to be mailed but in a new package; special handling instructions may be included if the new package is to be prepared differently.

6. Foreign Address, Will Mail—Foreign addresses returned by the USPS are in the form of three address lines of 37 bytes each. The address hygiene option takes that information and parses it together to form a 66-byte field, which is appended to the end of the input record. The mail piece is mailed.

7. Foreign Address, Do Not Mail—indicates that the recipient's mailing address is in a foreign country and that the mail piece should not be mailed.

It should be realized that any number of additional statuses may be used by the system.

In box 105, the option is offered to presort the mailing list based upon the final status assigned to each individual mail piece. If the client has chosen to have the mail presorted, processing proceeds to step 106, where the presort occurs. If not, processing proceeds to 107, where an Intelligent Mail® barcode is added to each record. This Intelligent Mail® barcode is in compliance with the U.S. Postal Services POSTNET standard. In box 108, the output is returned to the lettershop for printing.

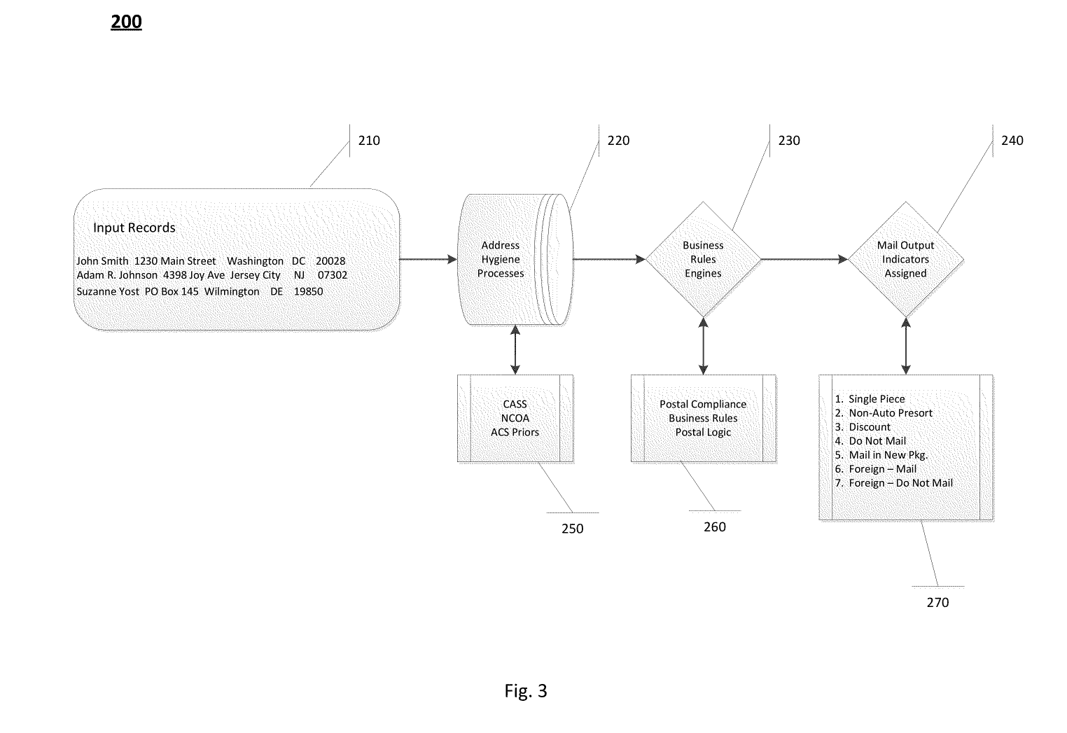

FIG. 3 shows a data flow oriented view of the process. In 210 input records from the mailing list database are sent to the address-hygiene processes, which include the CASS compliant software, the application of the NCOA database and the ACS process. At 230, the business rule engine applies the client's specific business rules as well as the global and local rules to make sure that the individual mailing records are in compliance with postal regulations and standards. In process 240 the final status is assigned to each individual mail piece as previously discussed.

The process has been described in terms of the functions, which are performed and, as would be realized by one of skill in the art, many implementations of a process performing these functions is possible. Additionally, it should be realized that the order in which the functions have been described is not part of the novelty of the invention and that some implementations may perform the functions in a different order or in parallel. The scope of the invention is as set forth in the following claims.

We claim:

1. A method for mail address validation and hygiene, said method implemented as software running on a computer, said method comprising the steps of:
receiving one or more mailing addresses for one or more mail pieces;
receiving one or more business rules specific to said one or more mailing addresses;
executing one or more processes on said one or more mailing addresses to identify individual mailing addresses which require reformatting or updating;
reformatting or updating said one or more identified mailing addresses in accordance with said business rules; and
checking to ensure that any potential applied changes do not cause a violation of postal regulations.

2. The method of claim 1 wherein said mailing addresses are identified for reformatting or updating to maximize postal rate discounts.

3. The method of claim 2 wherein said one or more processes includes an address formatting process.

4. The method of claim 3 wherein said address formatting process is CASS compliant.

5. The method of claim 2 wherein includes one or more address change processes.

6. The method of claim 5 wherein said one or more address change processes use the NCOA database.

7. The method of claim 5 wherein said one or more address change processes use an Address Change Service.

8. The method of claim 5 wherein said one or more address change processes use a proprietary Undeliverable As Addressed database.

9. The method of claim 1 wherein said business rules specific to said one or more mailing addresses enforce business restrictions on the reformatting and updating of individual mailing addresses.

10. The method of claim 9 wherein said method maximizes available postal rate discounts while still enforcing said business rules specific to said one or more mailing addresses.

11. The method of claim 1 further comprising the step of assigning a final disposition status to each individual mailing address.

12. The method of claim 11 wherein said final disposition status is selected from a group consisting of Single Piece, Non-Auto Presort, Full Discount, Do Not Mail, Mail In New Package, Foreign Address, Will Mail and Foreign Address, Do Not Mail.

13. The method of claim 11 further comprising the step of presorting those mailing addresses having a final disposition status which provides for a postal rate discount for presorting said mail piece.

14. The method of claim 11 further comprising the step of adding an Intelligent Mail barcode to all or some of said individual mailing addresses.

15. The method of claim 11 further comprising the step of updating a database containing said one or more mailing addresses.

16. The method of claim 1 wherein said step of receiving one or more mailing addresses for one or more mail pieces includes receiving said one or more addresses from a remote location.

17. The method of claim 16 wherein said method further comprises the step of returning said one or more mailing addresses to said remote location after some or all of said one or more mailing addresses have been reformatted and updated.

18. The method of claim 1 wherein said step of checking to ensure that any potential applied changes do not cause a violation of postal regulations includes the step of resolving differences between results obtained from the application if said business rules and rules which prevent the violations of U.S. postal regulations.
